(19) United States
(12) Patent Application Publication
(10) Pub. No.: US 2010/0135345 A1
(43) Pub. Date: Jun. 3, 2010

(54) WAVELENGTH CONVERSION LASER DEVICE AND NONLINEAR OPTICAL CRYSTAL USED IN THE SAME

(75) Inventors: Hong Ki Kim, Yongin (KR); Kiyoyuki Kawai, Suwon (KR); Yu Seung Kim, Anyang (KR)

Correspondence Address: MCDERMOTT WILL & EMERY LLP, 600 13TH STREET, N.W., WASHINGTON, DC, 20005-3096, US

(73) Assignee: Samsung Electro-Mechanics Co., Ltd., Gyunggi-Do (KR)

(21) Appl. No.: 12/699,577

(22) Filed: Feb. 3, 2010

Related U.S. Application Data
(62) Division of application No. 11/812,117, filed on Jun. 15, 2007, now abandoned.

(30) Foreign Application Priority Data
Aug. 30, 2006 (KR) 10-2006-0083108

(51) Int. Cl. H01S 3/10

(52) U.S. Cl. 372/22

(57) ABSTRACT

A wavelength conversion laser device and a nonlinear optical crystal used in the same. The wavelength conversion laser device includes a laser light source for emitting a predetermined wavelength beam, and a laser medium for exciting the predetermined wavelength beam from the laser light source into a fundamental beam. The wavelength conversion laser device further includes a nonlinear optical crystal composed of a KTiOPO₄ (KTP) crystal having b-c crystal plane as an incident surface of the fundamental beam to provide type II phase matching conditions. The KTP crystal converts the fundamental wavelength beam into a second harmonic generation beam.

### CLAIM OF PRIORITY

This application claims the benefit of Korean Patent Application No. 2006-0083108 filed on Aug. 30, 2006, in the Korean Intellectual Property Office, the disclosure of which is incorporated herein by reference.

### BACKGROUND OF THE INVENTION

1. Field of the Invention

The present invention relates to a wavelength conversion laser device and, more particularly, to a nonlinear optical crystal with improved operating temperature range and a wavelength conversion laser device including the same.

2. Description of the Related Art

Recently, there has been an increasing demand for semiconductor lasers in the fields of various displays and light record devices. In particular, as the application range of the semiconductor laser has been expanded to realize full colors in the display field, there has been an increasing demand for lasers having low power characteristics and capable of high output in a visible ray region.

To obtain red light, AlGaInP or AlGaAs-based semiconductor lasers are relatively easily produced and used. However, in order to obtain green or blue light, it is difficult to grow a semiconductor material due to the unique lattice constant or thermal expansion coefficient of the group III nitride semiconductor. Also, there are problems related to crystal defects such as dislocation, which degrades the reliability and shortens the lifetime of the lasers.

To remedy such problems, a method of converting a wavelength using non-linear characteristics has been used. Diode-pumped Solid-State (DPSS) lasers have gained attention as a method of using the non-linear characteristics. For example, light of a pump laser diode in a band of 808 nm is made to be incident into a crystal like Nd:YAG to obtain a wavelength in the vicinity of 1060 nm, and the frequency is increased by two folds using a nonlinear optical crystal to obtain green light in the vicinity of 530 nm.

In the DPSS laser device, the nonlinear optical crystal such as a crystal for second harmonic generation exhibits refractive index changes due to temperature according to the crystal direction, and thus the incident angle for phase matching, i.e., for optimal wavelength conversion efficiency varies according to the temperature. Therefore, there is required a method for maintaining regulated wavelength conversion efficiency of the non-linear optical crystal within the temperature range of the laser device.

Conventionally, there has been a method of adopting Thermo-electric Cooler (TEC) using a Peltier device and a heat radiating structure. In order to overcome such drawbacks, U.S. Pat. No. 6,614,584 to Govorkov et al. suggests monitoring the light output and displacing the non-linear optical crystal in response to the monitoring result to obtain an incident angle of optimal phase matching condition. These conventional methods however increase power consumption or the size of the system.

In particular, such increase in the power consumption and size of the system is considered a severe hindrance in an ultra-miniaturized product such as a portable projector, which has been in the spotlight recently as an application of the laser device.

### SUMMARY OF THE INVENTION

The present invention has been made to solve the foregoing problems of the prior art and therefore an aspect of the present invention is to provide a wavelength conversion laser device having a nonlinear optical crystal which can maintain a desired level of wavelength conversion efficiency in a wide operating temperature range.

According to an aspect of the invention, the invention provides a wavelength conversion laser device, which includes a laser light source for emitting a predetermined wavelength beam; a laser medium for exciting the predetermined wavelength beam from the laser light source into a fundamental beam; and a nonlinear optical crystal composed of a KTiOPO₄ (KTP) crystal having b-c crystal plane as an incident surface of the fundamental beam to provide type II phase matching conditions, the KTP crystal converting the fundamental wavelength beam into a second harmonic generation beam.

In the specification, “incident surface” is defined as a surface formed by an incident beam and a reflected beam.

In addition, the KTP crystal is provided with an angle ranging from 0 to 90° between c-axis and the fundamental beam so as to ensure maximum conversion efficiency in accordance with a wavelength of the fundamental beam at room temperature (about 20° C.).

It is preferable that when the fundamental beam has a wavelength of 1064 nm, the KTP crystal is oriented to have phase matching angles satisfying Φ=90° and θ=68.7° (where Φ is defined as an angle an a-axis forms with a-b plane component of the fundamental beam, and θ is an angle formed between c-axis of the crystal and an incident beam), and can have 0.1° of Full Width Half Maximum (FWHM). Such FWHM can be understood as a tilting angle range for compensating the phase matching conditions.

According to an embodiment of the present invention, the laser medium can be a crystal selected from the group consisting of Nd:YVO₄, Nd:YAG and Nd:GdVO₄, and it is preferable that the wavelength conversion laser device further includes a resonator structure in order to increase an output of the second harmonic beam.

In this case, the resonator structure may include a first mirror disposed between the laser light source and the laser medium, the first mirror having high reflectivity with respect to the wavelength of the fundamental beam and anti-reflectivity with respect to the wavelength of the laser light source; and a second mirror disposed at an output side of the nonlinear optical crystal, the second mirror having high reflectivity with respect to the wavelength of the fundamental beam and anti-reflectivity with respect to the wavelength of the second harmonic generation beam.

According to another aspect of the invention, the invention provides a nonlinear optical crystal composed of a KTiOPO₄ (KTP) crystal having a surface cut perpendicular to a-b crystal plane so as to have b-c crystal plane as an incident surface of a fundamental beam, wherein the nonlinear optical crystal receives the fundamental beam from a wavelength conversion laser device and generate a second harmonic generation beam.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1(a) and 1(b) are schematic configuration view illustrating a wavelength conversion laser device according to an embodiment of the present invention;

FIG. 2 is a schematic view illustrating a wavelength conversion laser device according to another embodiment of the present invention;

FIGS. 3(a) and (b) show the direction of an incident beam in a crystal structure of KTiOPO₄ (KTP) adopted in the present invention;

FIG. 4 is a graph illustrating the intensity of SHG (532 nm) according to the angle θ change at a wavelength of 1064 nm of a fundamental wave; and

FIG. 5 is a graph illustrating SHG light efficiency according to the temperature of the nonlinear optical crystal KTP adopted in the present invention.

### DETAILED DESCRIPTION OF THE PREFERRED EMBODIMENT

Exemplary embodiments of the present invention will now be described in detail with reference to the accompanying drawings.

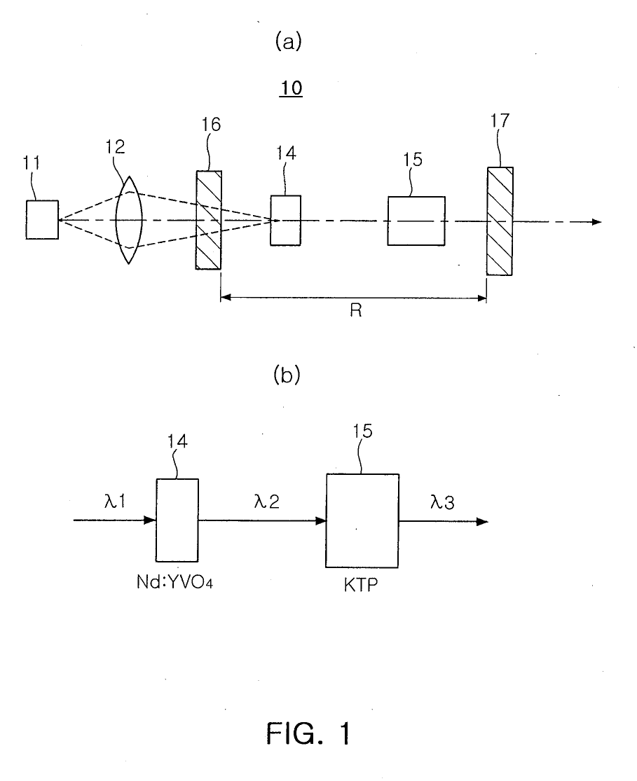

FIGS. 1(a) and (b) are schematic configuration views illustrating a wavelength conversion laser device according to an embodiment of the present invention.

As shown in FIG. 1(a) along with FIG. 1(b), the wavelength conversion laser device 10 according to this embodiment includes a laser light source 11 for generating a predetermined wavelength beam λ₁, a laser medium 14 exciting the wavelength beam λ₁ into a fundamental beam λ₂, and a nonlinear optical crystal 15 for converting the fundamental wavelength beam λ₂ into a second harmonic generation (SHG) beam λ₃.

If necessary, various optical systems can be included additionally. For example, a condenser lens 12 for condensing light from the laser light source can be also included as presented in this embodiment.

In this embodiment, the wavelength conversion laser device includes a resonator structure R in order to increase the output efficiency of the second harmonic generation beam. The resonator structure R adopted in this embodiment may include a first mirror 16 disposed between the condenser lens 12 and the laser medium 14, and a second mirror 17 disposed at an output side of the nonlinear optical crystal 15.

In this case, the first mirror 16 has high reflectivity with respect to the wavelength of the fundamental beam λ₂ and has anti-reflectivity with respect to the wavelength of the laser light source λ₁. In addition, the second mirror 17 has high reflectivity with respect to the wavelength of the fundamental beam λ₂ and has anti-reflectivity with respect to the wavelength of the second harmonic generation beam λ₃. Therefore, the resonator structure R allows selective resonation of the fundamental beam λ₂ that was not converted initially by the nonlinear optical crystal to significantly increase the conversion efficiency.

More specifically, as shown in FIG. 1(b), the wavelength light λ₁ of about 808 nm is generated from the laser light source 11 and excited by the laser medium 14 and outputted as the fundamental beam λ₂ of about 1064 nm. The fundamental beam λ₂ can be converted to the second harmonic generation beam λ₃ of 532 nm which corresponds to a half the wavelength of the fundamental beam λ₂. In this embodiment, the laser medium 14 can be a crystal selected from Nd:YVO₄, Nd:YAG and Nd:GdVO₄.

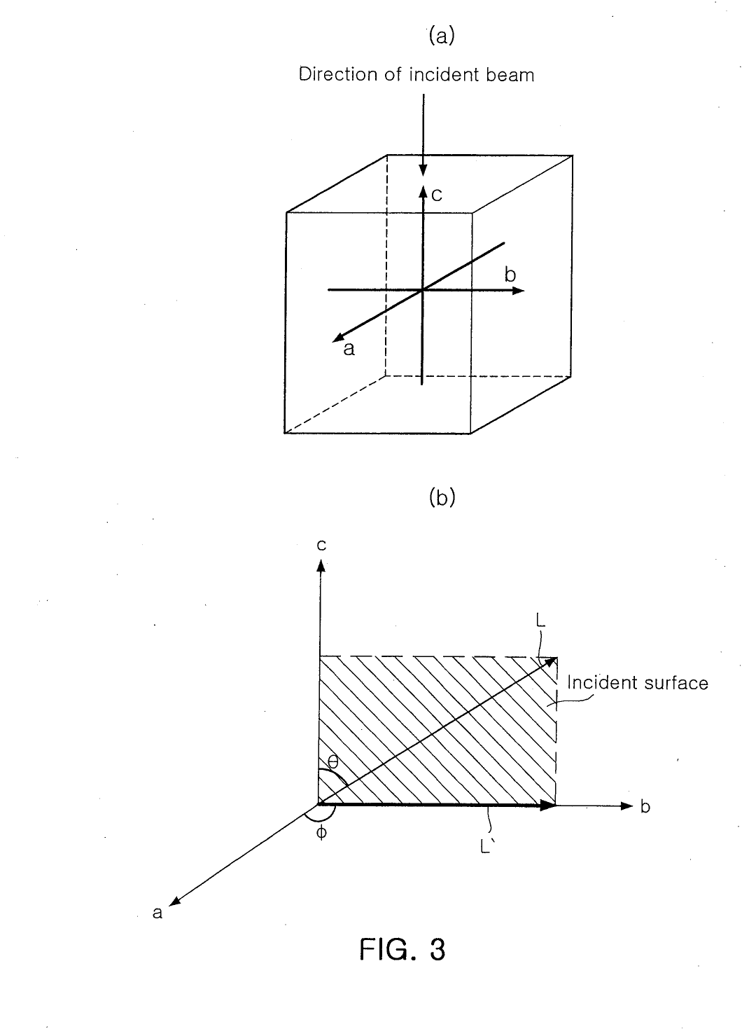

In the present invention, the nonlinear optical crystal 15 adopts a KTiOPO₄ (KTP) crystal having b-c crystal plane as an incident surface. In general, the KTP nonlinear optical crystal uses a-b crystal plane as the incident surface. In particular, the KTP nonlinear optical crystal 15 adopts phase matching conditions of Φ=23.5° and θ=90° in order to ensure maximum conversion efficiency. (Refer to the description related to FIG. 3 later)

However, as mentioned above, the crystal structure of the nonlinear optical crystal 15 changes sensitively according to the temperature, and thus the nonlinear optical crystal 15 has varying refractive indices even at the same incident angle. Due to this condition, the SHG conversion efficiency of the nonlinear optical crystal is largely dependent on the operating temperature.

Therefore, the inventor has been interested in finding ways to expand the operating temperature range while ensuring a suitable range of SHG conversion efficiency of the nonlinear optical crystal, and has found that the operating temperature range can be significantly improved by selecting a crystal plane, that varies in a small range of the wavelength conversion efficiency with the operating temperature, as an incident surface. That is, as in this embodiment, the KTP crystal can be oriented to provide type II phase matching conditions with b-c crystal plane as an incident surface of the fundamental beam, thereby allowing an operating temperature range several times expanded from that of the conventional KTP crystal (a-b crystal plane).

Although the KTP nonlinear optical crystal 15 satisfying the conditions proposed in the present invention may have relatively lower conversion efficiency compared to the prior art, the relatively low conversion efficiency can be compensated by improving the resonator structure 16 and 17 shown in this embodiment. Therefore, the expansion of the operating temperature range according to the present invention can be considerably advantageous overall.

According to the present invention, the KTP nonlinear optical crystal 15 is disposed such that b-c crystal plane is the incident surface of the fundamental beam λ₂. The phase matching conditions for maximum conversion efficiency are dependent on not only the temperature but also the wavelength of the fundamental beam. Thus, in accordance with the wavelength of the fundamental beam, θ can be adjusted suitably while maintaining b-c crystal plane as the incident surface to obtain maximum conversion efficiency.

In addition, supposing that the fundamental beam λ₂ of 1064 nm is used at room temperature, it is preferable that the KTP crystal is disposed to have phase matching angles satisfying Φ=90° and θ=68.7°. The angle θ for phase matching may have a Full Width Half Maximum (FWHM) of 0.1°. Although not shown in this embodiment, other known adjusting means of the incident angle can be adopted to provide phase matching conditions in accordance with the temperature, in which case, the aforementioned error range can be understood as a tilting angle range for compensating for the phase matching conditions in accordance with the temperature change.

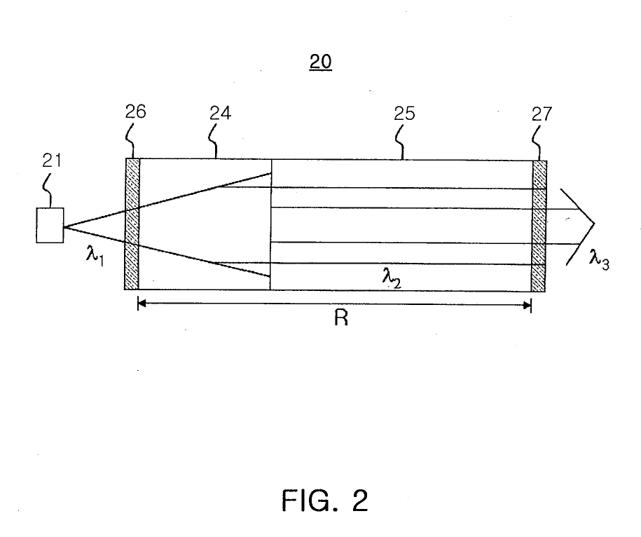

FIG. 2 is a schematic view illustrating a wavelength conversion laser device according to another embodiment of the present invention.

Similar to the embodiment shown in FIG. 1, the wavelength conversion laser device 20 according to this embodiment includes a laser light source 21 for generating a predetermined wavelength beam λ₁, a laser medium 24 for exciting the wavelength beam λ₁ into a fundamental beam λ₂, and a KTP nonlinear optical crystal 25 for converting the fundamental beam λ₂ to a second harmonic generation (SHG) beam λ₃. In addition, the wavelength conversion laser device 20 includes first and second mirrors 26 and 27 as a resonator structure R for increasing the output efficiency of the second harmonic generation beam.

However, unlike in the embodiment shown in FIG. 1, an exit surface of the laser medium 24 is attached to an incident surface of the KTP nonlinear optical crystal 25. Here, the incident surface of the KTP optical crystal 25 has a surface cut perpendicular to a-b crystal plane so as to have b-c crystal plane as the incident surface of the fundamental beam. In addition, the first and second mirrors 26 and 27 are disposed at the incident surface and at the exit surface of the KTP optical crystal 25, respectively.

As described above, this embodiment provides a laser device of a very compact structure, which does not require a precise process of aligning the components.

FIG. 3(a) illustrates a crystal structure of KTiOPO₄ (KTP), the nonlinear optical crystal adopted in the present invention.

As shown in FIG. 3(a), the KTiOPO₄ (KTP) nonlinear optical crystal is an orthorhombic structure (a<b<c), and is cut perpendicular to a-b crystal plane so as to have b-c crystal plane as an incident surface of the fundamental beam. As described above, according to the incidence condition of the fundamental beam to the KTP crystal, with b-c crystal plane as the incident surface, θ can be adjusted in a range of 0 to 90° to allow maximum conversion efficiency in accordance with the wavelength condition of the fundamental beam.

As illustrated in FIG. 3(b), it is preferable that when the fundamental beam is 1064 nm, the fundamental beam has phase matching angles satisfying the incidence conditions Φ=90° and θ=68.7°. Here, Φ is defined as an angle formed between a-axis and a-b planar component L′ of an incident beam L, and θ is defined as an angle formed between c-axis of the KTP crystal and the incident beam.

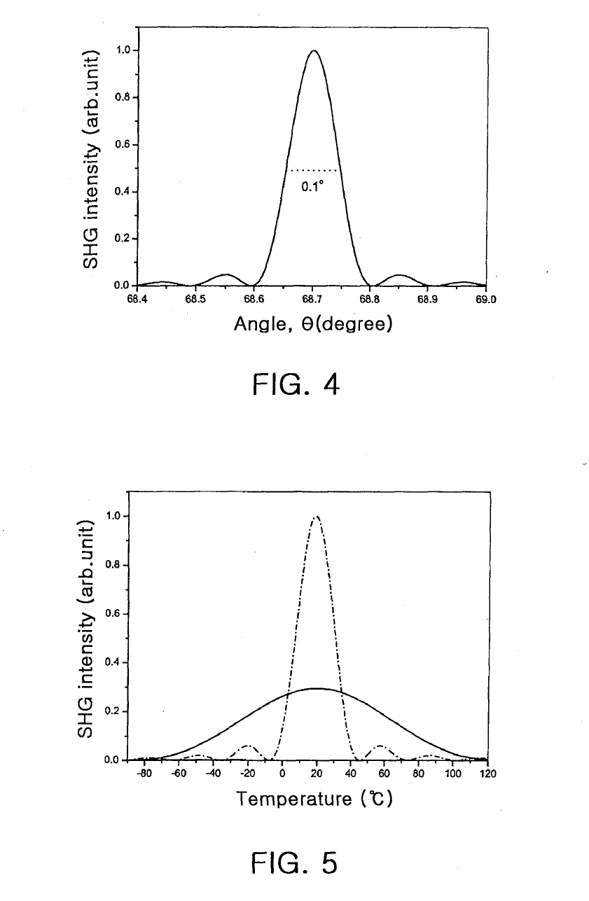

The phase matching condition in consideration of the wavelength conversion efficiency can be explained in greater detail with reference to FIG. 4.

FIG. 4 is a graph showing the intensity of SHG (532 nm) in accordance with angle θ change given that the fundamental beam has a wavelength of 1064 nm.

The fundamental beam λ₂ of 1064 nm was made to be incident at a room temperature condition (about 20° C.) into b-c crystal plane (Φ=90°) of the KTP nonlinear optical crystal, and while the KTP crystal was adjusted to change the angle θ between the incident direction of the fundamental beam and the c-axis, the wavelength conversion efficiency was measured. The result is shown in FIG. 4.

As shown in FIG. 4, the maximum conversion efficiency is exhibited at θ=68.7° with a FWHM of 0.1°. Here, the FWHM can be understood as a tilting angle range for compensating the phase matching conditions in accordance with the temperature change. As described above, the phase matching conditions for ensuring the maximum conversion efficiency at a normal temperature condition can be defined as Φ=90° and θ=68.7°.

Of course, the maximum conversion efficiency varies with the wavelength of the fundamental beam. Thus, in the case where the fundamental beam has a different wavelength, θ can be adjusted suitably in the range of 0 to 90° while maintaining the b-c crystal plane as the incident surface, thereby obtaining the maximum conversion efficiency.

FIG. 5 is a graph showing the SHG light efficiency in accordance with the temperature of the KTP nonlinear optical crystal according to the present invention. The graph is based on the result comparing the phase matching conditions of the conventional nonlinear optical crystal and the phase matching conditions of the nonlinear optical crystal according to the present invention, when the fundamental beam of 1064 nm is converted to SHG of 532 nm at room temperature.

Referring to the graph of FIG. 5, the dotted line denotes the intensity of the SHG in accordance with the operating temperature at the phase matching conditions (Φ=23.5° and) θ=90° of the conventional KTP nonlinear optical crystal. On the other hand, the solid line denotes the intensity of the SHG in accordance with the operating temperature of the KTP nonlinear optical crystal under the preferred conditions (Φ=90° and θ=68.7° according to the present invention.

Of course, the phase matching condition of the conventional nonlinear optical crystal appears to be advantageous but its operating temperature range is actually very narrow.

For example, in the conventional KTP crystal, the allowable FWHM (the temperature range at which the SHG efficiency decreases by half) is only about 24° C., whereas the in the KTP crystal according to the preferred condition of the present invention, the allowable FWHM is about 97° C., which is greater by approximately 4 times from the conventional one.

Further, when the temperature of the KTP crystal is about 40° C., the SHG conversion efficiency of the conventional KTP crystal is close to 0, but the SHG conversion efficiency of the KTP crystal according to the preferred condition of the present invention is about 0.26, with only about 10% of loss compared to the maximum conversion efficiency (0.29) at 20° C.

Therefore, as shown in the graph of FIG. 5, disposing the KTP crystal to satisfy the incident conditions according to the present invention ensures a large operating temperature range.

In addition, as described above, supposing that a predetermined range of improvement in the SHG conversion efficiency can be expected by improving the capacity of the resonator, the wavelength conversion laser device is capable of operating in a large operating temperature range with high reliability, and does not require additional apparatuses for compensating the conversion efficiency such as a Thermal-electric Cooler (TEC).

The present invention as set forth above provides a KTP nonlinear crystal with relatively stable SHG conversion efficiency according to the temperature change, thereby providing a wavelength conversion laser device capable of stably operating in a large temperature range without an additional apparatus for compensating the conversion efficiency according to the temperature, such as a Thermo-electric Cooler (TEC). Therefore, the present invention provides a wavelength conversion laser device suitable for an ultra-miniaturized product such as a portable projector in spotlight recently as an application of the laser device.

While the present invention has been shown and described in connection with the exemplary embodiments, it will be apparent to those skilled in the art that modifications and variations can be made without departing from the spirit and scope of the invention as defined by the appended claims.

1-8. (canceled)

9. A wavelength conversion laser device comprising:
a laser light source for emitting a predetermined wavelength beam;
a laser medium for exciting the predetermined wavelength beam from the laser light source into a fundamental beam; and
a nonlinear optical crystal comprising a KTiOPO₄(KTP) crystal having b-c crystal plane as an incident surface of the fundamental beam to provide type II phase matching conditions, the KTP crystal converting the fundamental wavelength beam into a second harmonic generation beam, wherein
the laser medium comprises a crystal selected from the group consisting of Nd:YVO₄, Nd:YAG and Nd:GdVO₄.
